(19) United States
(12) Patent Application Publication
(10) Pub. No.: US 2026/0146568 A1
(43) Pub. Date: May 28, 2026

(54) METHOD AND DEVICE FOR CONTROLLING A THROTTLE VALVE IN AN INTAKE MANIFOLD OF AN INTERNAL COMBUSTION ENGINE

(71) Applicant: Robert Bosch GmbH, Stuttgart (DE)

(72) Inventors: Rene Wackerow, Ditzingen (DE); Stephan Otto, Weissach (DE)

(21) Appl. No.: 19/365,394

(22) Filed: Oct. 22, 2025

(30) Foreign Application Priority Data
Nov. 4, 2024 (DE) 10 2024 210 579.1

(51) Int. Cl. F02D 41/00; F02D 41/10

(52) U.S. Cl. CPC F02D 41/0002; F02D 41/10; F02D 2200/101

(57) ABSTRACT

A method and a device for controlling a throttle valve in an intake manifold of an internal combustion engine. Power requested by a user of the internal combustion engine is implemented through actuation signals for opening the throttle valve. The power requested by the user at a first point in time is implemented at a second, later point in time through actuation signals of the throttle valve.

### BACKGROUND INFORMATION

The present invention relates to a method and a device for controlling a throttle valve in an intake manifold of an internal combustion engine.

It is conventional to control the power of an internal combustion engine by influencing the quantity of air sucked in by the internal combustion engine. For this purpose, a throttle valve is actuated in an intake manifold of the internal combustion engine in order to influence the quantity of air that is sucked in by the internal combustion engine. With unfavorable actuation of the throttle valve, an unwanted engine stop can occur, typically in the near-idle range due to improper clutch operation.

### SUMMARY

The method according to the present invention and the device according to the present invention having certain features of the present invention may have the advantage that improved actuation of the throttle valve is ensured. According to an example embodiment of the present invention, a method is provided for controlling a throttle valve in an intake manifold of an internal combustion engine, in which power requested by a user of the internal combustion engine is implemented through actuation signals for opening the throttle valve, wherein the power requested by the user at a first point in time is implemented at a second, later point in time through actuation signals of the throttle valve.

According to the present invention, in particular, a change in the position of the throttle valve that could lead to undesirable operating conditions of the internal combustion engine is avoided. This ensures the desired operation of the internal combustion engine. In particular, the method according to the present invention and the device according to the present invention can significantly reduce the risk of an unwanted engine stop of the internal combustion engine in the event of a rapid change in driver demand.

Further advantages and improvements result from the measures of the present invention disclosed herein. It is particularly easy to select a suitable crankshaft angle for actuating the throttle valve. This crankshaft angle can expediently be selected such that the quantity of fuel injected can be adjusted in accordance with the actuation of the throttle valve. In this case, a time offset between the actuation of the throttle valve and the resulting quantity of air can expediently be taken into account. This improves the quality of the throttle valve actuation. Furthermore, the compression work of the internal combustion engine, which results from a change in the position of the throttle valve, is expediently taken into account. For this purpose, the adjustment of the throttle valve is in particular limited to a maximum value. An unfavorable adjustment of the throttle valve is problematic for the internal combustion engine, in particular in low rotational speed ranges. It may therefore be provided that the method according to the present invention is carried out only up to a predetermined rotational speed of the internal combustion engine. It is particularly easy to provide for a change in the power of the internal combustion engine, which is requested when the air inlet valve is open, to be implemented through actuation signals sent to the throttle valve only when the air inlet valve is closed again. If actuation signals are computed in predetermined angle windows, specific angle windows can be specified for computation and output. Particularly advantageous in this context is an angle window immediately before the air inlet valve closes.

### BRIEF DESCRIPTION OF THE DRAWINGS

Exemplary embodiments of the present invention are shown in the figures and explained in more detail in the following description.

FIG. 1 is a schematic view of an internal combustion engine.

FIGS. 2A-2D show various signals of the internal combustion engine plotted against an angle scale, according to an example embodiment of the present invention.

### DETAILED DESCRIPTION OF EXAMPLE EMBODIMENTS

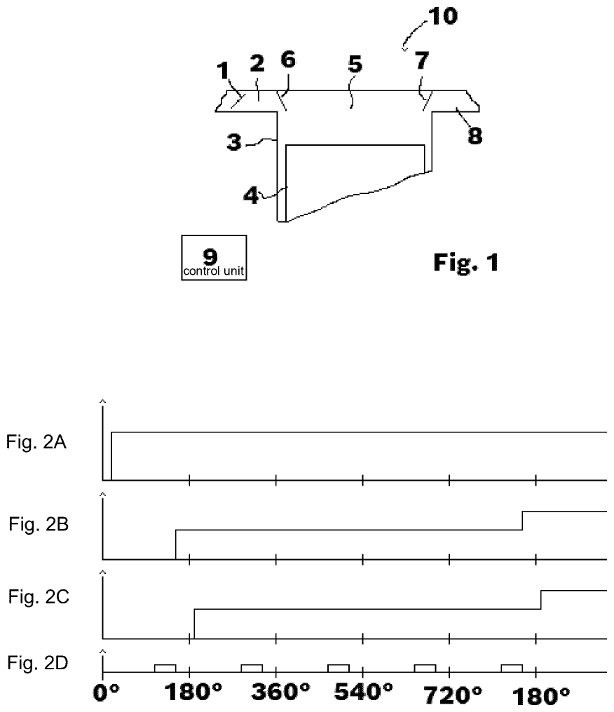

FIG. 1 schematically shows an internal combustion engine 10 with a cylinder 3, in which a piston 4 is arranged. Above the piston 4, the cylinder 3 forms a combustion chamber 5, into which a mixture of fuel and air is introduced and burned. Combustion of the fuel-air mixture in the combustion chamber 5 increases the pressure in the combustion chamber 5 and, by means of movement of the piston 4 in the cylinder 3 by means of a connecting rod (not shown here) and a crankshaft, is converted into mechanical work. Thus, it is a generally conventional Otto or diesel internal combustion engine.

For supplying air into the combustion chamber 5, an intake manifold 2 is provided, in which the quantity of supplied air is controlled by a throttle valve 1. By opening and closing the throttle valve 1, the quantity of air introduced into the combustion chamber 5 is controlled. Furthermore, a fuel injection valve is provided, either in the intake manifold 2 or directly in the combustion chamber 5 and injects fuel either into the flowing air in the intake manifold 2 or directly into the combustion chamber 5. For the sake of simplicity, this fuel injection valve is not shown in FIG. 1. For removing the exhaust gases after combustion, an exhaust-gas pipe 8 is provided, through which the combusted exhaust gases are transported out of the combustion chamber 5. Furthermore, an air inlet valve 6 and an exhaust valve 7 are shown schematically in FIG. 1. By opening and closing the air inlet valve 6 and the exhaust valve 7, the combustion chamber 5 is connected to the intake manifold 2 or to the exhaust-gas pipe 8, depending on the operating phase of the internal combustion engine 10. For controlling the internal combustion engine 10, a control unit 9 is also shown, which generates signals for actuating the throttle valve 1 or the injection valves.

Such an internal combustion engine 10 is typically operated using a four-stroke process. In a first intake stroke, fresh air is sucked into the combustion chamber 5 by the opening of the air inlet valve 6 and the movement of the piston 4 from a top dead center to a bottom dead center. The movement of the piston creates an underpressure in the combustion chamber, which causes air to be sucked in through the intake manifold 2. By opening the throttle valve 1, the quantity of air introduced into the combustion chamber 5 is controlled. When the fuel is injected into the intake manifold 2, the fuel is also introduced into the combustion chamber 5 in this phase. This is followed by a compression stroke, in which the piston 4 moves from the bottom dead center back to the top dead center, thus compressing the fuel-air mixture in the combustion chamber. If fuel is injected directly into the combustion chamber 5, fuel can also be injected during the compression stroke. After the compression stroke, the combustion stroke occurs, in which the mixture of fuel and air is combusted in the combustion chamber 5. This combustion greatly increases the pressure in the combustion chamber 5, and this pressure is converted into mechanical work by means of movement of the piston 4 from the top dead center to the bottom dead center. During the combustion stroke, both the air inlet valve 6 and the exhaust valve 7 are closed. This is followed by the exhaust stroke, in which the exhaust valve 7 is opened, and, due to movement of the piston 4 from the bottom dead center to the top dead center, the exhaust gases, i.e., the waste products of combustion, are transported out of the combustion chamber 5 through the exhaust-gas pipe 8.

In an internal combustion engine having only one cylinder, torque is generated and the internal combustion engine accelerates only during the combustion stroke, whereas, during the other strokes (the intake stroke, the compression stroke, and the exhaust stroke), the internal combustion engine is braked and thus slows down. During the combustion stroke, energy is fed into the mechanical system comprising the piston, connecting rod and crankshaft, and the energy must be sufficient to cover the energy demand of the exhaust stroke, intake stroke and compression stroke up to the next combustion stroke. It must therefore be ensured that the acceleration of the internal combustion engine generated by the combustion stroke is sufficient to maintain the rotation of the internal combustion engine up to the next combustion stroke. In this context, it can be problematic, in particular in internal combustion engines having only one cylinder and a very small intake manifold 2 volume, if a very rapid and substantial change in the position of the throttle valve 1 occurs. A substantial change in the air quantity sucked in results in a substantial change in particular in the energy demand of the compression stroke. This situation is explained with reference to FIG. 2.

FIGS. 2A-2D show different operating parameters of an internal combustion engine compared to different power strokes of the internal combustion engine. A complete working cycle of the internal combustion engine from 0° to 720° and a subsequent intake stroke between 0° and 180° are shown. The crankshaft angles of the internal combustion engine are plotted to the right, an intake stroke extending from the angular range 0° to 180°, a compression stroke from 180° to 360°, a combustion stroke from 360° to 540°, and an exhaust stroke from 540° to 720°. When 720° is reached, the working cycle of the internal combustion engine begins again, i.e., 720° again corresponds to 0° with respect to a new working cycle.

FIG. 2A shows a power request from a user to the internal combustion engine. It is shown that the power request to the internal combustion engine is sharply increased at a very small angle (approx. 20°) at the beginning of the intake stroke and is then held at this value. If, in accordance with this request, the throttle valve 1 is opened at the same time in order to introduce a correspondingly large quantity of air into the combustion chamber 5, this leads to the problem that a correspondingly large quantity of air must be compressed in the subsequent compression stroke. However, since the energy required for compression or compression work must be generated by the previous combustion, and it was not yet known during this combustion that this sudden increase in the quantity of air would occur, it is possible that the increased quantity of air cannot be compressed at all. In this case, an unwanted engine stop would occur, i.e., the internal combustion engine would come to a standstill.

Furthermore, in this case, the quantity of fuel required based on the quantity of air might not be introduced into the combustion chamber 5 in a timely manner. Since the need for a higher quantity of fuel is only known at the point in time that the quantity of air is increased, this required new quantity of fuel must be recalculated. The time required for this may be too short, or the time required for the computation or the sum of the time required for the computation and the time for the injection may be too short. The computation of the quantity of fuel may also be delayed since such computations cannot be carried out immediately but are only possible at certain points in time. These problems are particularly severe when the volume of the intake manifold 2 is very small in relation to the volume of the combustion chamber 5 since, in this configuration, a change in the position of the throttle valve very rapidly leads to a change in the air charge of the combustion chamber 5.

According to the present invention, it is therefore proposed that a change in the power of the internal combustion engine requested by a user of the internal combustion engine at a first point in time be implemented only at a second, later point in time by means of corresponding control signals of the throttle valve 1. The second, later point in time is selected in such a way that the aforementioned problems due to a change in the position of the throttle valve at an unfavorable first point in time are avoided.

In FIG. 2B, the actuation signals of the control unit 9 to the throttle valve 1 are shown plotted against the crankshaft angles. As can be seen in FIG. 2B, the requested change in power is implemented at a later, second point in time by corresponding control signals of the control unit 9 to the throttle valve 1. The corresponding signal is issued shortly before the end of the intake stroke at an angle of approx. 170°. FIG. 2C shows the resulting actual position of the throttle valve 1. There is a time lag between the actuation signals, which were issued at approx. 170°, and the actual implementation by the throttle valve, which means that the actual change in the position of the throttle valve 1 occurs only at approx. 190° of crankshaft angle. The throttle valve 1 is therefore opened only when the air inlet valve 6 is already closed, and therefore no longer has any effect on the compression occurring in the compression stroke between 180° and 360° or on the combustion stroke occurring between 360° and 540°.

There is then sufficient time until the next combustion stroke to make the necessary computations of the quantity of fuel for the changed quantity of air.

Furthermore, the power increase requested by the user in FIG. 2A was not fully converted to corresponding actuation signals for the throttle valve. As FIG. 2B shows, the change in the actuation of the throttle valve occurs in such a way that the power requested by the user of the internal combustion engine is not fully realized. This occurs only in the next intake stroke, i.e., in the angular range between 720° and 180°. By limiting the change in the actuation of the throttle valve 1 to a maximum value, it is ensured that a sufficient amount of energy is generated in the combustion stroke (360° to 540°) to ensure the subsequent exhaust stroke, intake stroke and the subsequent compression stroke with the increased quantity of air.

The method according to FIGS. 2A-2D ensures reliable operation of the internal combustion engine. If a user requests a change in power at an unfavorable first point in time, this is only implemented at a second, later point in time, one suitable for operation of the internal combustion engine, by sending corresponding actuation signals to the throttle valve 1. For the selection of the second, later point in time, a specific crankshaft angle of the internal combustion engine in the working cycle of the internal combustion engine is in particular selected. This is done in particular in such a way that excessive changes are avoided while the air inlet valve is open.

Furthermore, the time required to calculate the quantity of fuel injected should be taken into account. Such computations require a certain amount of time or are only planned for certain crankshaft angles. The time required to calculate the injection quantity or the point in time at which the injection quantity is calculated should therefore be taken into account when selecting the second point in time.

Furthermore, it should be taken into account that there is a time delay between the throttle valve being actuated and the actual change in the quantity of air controlled by the throttle valve.

Furthermore, it should be taken into account that a change in the quantity of air also causes a change in the necessary work or energy for the subsequent compression of the quantity of air in the combustion chamber 5. This should be taken into account both with regard to the selection of the second point in time and with regard to the magnitude of the change in the throttle valve position. In particular, in the case of substantial increases in the power of the internal combustion engine requested by the user, a correspondingly substantial adjustment of the throttle valve 1 should not be carried out in one step. It is useful to distribute a requested substantial adjustment of the throttle valve over a plurality of individual sub-steps in successive combustion events. This can be achieved simply by limiting any change in the actuation of the throttle valve to maximum values.

A change in the position of the throttle valve at unfavorable points in time is particularly severe when the rotational speed of the internal combustion engine is low. This is in particular due to the fact that the energy stored in the mechanical system comprising the piston, connecting rod and crankshaft is significantly lower at low rotational speeds than at high rotational speeds. It is therefore particularly simple to apply the method according to the present invention only up to a certain rotational speed. Alternatively, different procedures may be provided for different rotational speed ranges; for example, the maximum permissible adjustment of the throttle valve can depend on the rotational speed.

As already explained above, a substantial adjustment of the throttle valve is in particular problematic when the air inlet valve is open at this point in time, i.e., during the intake stroke. It may therefore be provided in principle that adjustment of the throttle valve is permitted only when the air inlet valve is closed.

If the computation of control signals for actuating the internal combustion engine is performed only within predetermined angle windows of the internal combustion engine, then it is particularly easy to provide the computation and output of actuation signal for the throttle valve 1 only within a specific angle window. This is shown in FIG. 2D. FIG. 2D shows time windows for the computation of actuation signals. These occur every 180° and begin, for example, at an angle of 110° in the intake stroke, at an angle of 290° in the compression stroke, at an angle of 470° in the combustion stroke, and at an angle of 650° in the exhaust stroke. With the length of the typical computation window of approx. 30° of crankshaft angle shown in FIG. 2D, the computation window that begins at 110° of crankshaft angle is in particular suitable for computing and outputting actuation signals for the throttle valve 1. With this selection of computation windows for the computation of control signals, this computation window is therefore suitable for the computation and output of actuation signals for the throttle valve 1.

1-10. (canceled)

11. A method for controlling a throttle valve in an intake manifold of an internal combustion engine, the method comprising:
implementing power requested by a user of the internal combustion engine using actuation signals for opening the throttle valve, wherein the power requested by the user at a first point in time is implemented at a second, later point in time using the actuation signals for the throttle valve.

12. The method according to claim 11, wherein a specific crankshaft angle of the internal combustion engine in a working cycle of the internal combustion engine is selected for the second, later point in time.

13. The method according to claim 12, wherein the second, later point in time is selected such that, at the selected second point in time in the working cycle of the internal combustion engine, an adjustment of an injection quantity of fuel to an air quantity resulting from actuation of the throttle valve can still be carried out.

14. The method according to claim 12, wherein, for the selection of the second, later point in time, a time delay between actuation of the throttle valve and a change, caused by the actuation, in a quantity of air flowing into the internal combustion engine is taken into account.

15. The method according to claim 11, wherein compression work of the internal combustion engine is taken into account for the selection of the second, later point in time.

16. The method according to claim 11, wherein a change in the actuation signals is limited to a maximum value.

17. The method according to claim 11, wherein, for the selection of the second, later point in time, a rotational speed of the internal combustion engine is taken into account, in that the implementation of the power requested by the user at the first point in time is carried out at the second, later point in time only up to a predetermined rotational speed.

18. The method according to claim 11, wherein power requested by the user when an air inlet valve of the internal combustion engine is open is implemented through actuation signals of the throttle valve at a later point in time at which the air inlet valve is closed.

19. The method according to claim 11, wherein when a working cycle of the internal combustion engine extending over 720° of crankshaft angle, the actuation signals are calculated at fixed crankshaft angles, and in the calculation, actuation for the throttle valve is effected immediately before air inlet valves close.

20. A device for controlling a throttle valve in an intake manifold of an internal combustion engine, the device configured to implement power requested by a user of the internal combustion engine using actuation signals for opening the throttle valve, wherein the power requested by the user at a first point in time is implemented by the device at a second, later point in time using the actuation signals of the throttle valve.

21. The device according to claim 20, wherein the device comprises a control unit configured to implement the power requested by the user at the first point in time at the second, later point in time using the actuation signals of the throttle valve.
